(19) United States
(12) Patent Application Publication
(10) Pub. No.: US 2016/0148149 A1
(43) Pub. Date: May 26, 2016

(54) METHOD AND SYSTEM FOR DETERMINING SHELF LIFE OF A CONSUMABLE PRODUCT

(71) Applicant: Wipro Limited, Bangalore (IN)

(72) Inventors: Upendra Suddamalla, Anantapur (IN); Anandaraj Thangappan, Bangalore (IN)

(21) Appl. No.: 14/631,056

(22) Filed: Feb. 25, 2015

(30) Foreign Application Priority Data
Nov. 26, 2014 (IN) 5931/CHE/2014

(51) Int. Cl. G06Q 10/08

(52) U.S. Cl. CPC G06Q 10/087

(57) ABSTRACT

A method, shelf life analysis computing device, and non-transitory computer readable medium for determining shelf life of a consumable product is disclosed. The system may comprise one or more activity monitoring sensors to detect an activity associated with the consumable product. The system may further comprise one or more quality sensors to collect quality data of the consumable product upon detecting the activity. The shelf life of the consumable product may then be determined based on the quality data of the consumable product.

This application claims the benefit of Indian Patent Application No. 5931/CHE/2014 filed Nov. 26, 2014, which is hereby incorporated by reference in its entirety.

### FIELD

This disclosure relates generally to monitoring quality of consumable products, and more particularly to system and method of determining shelf life of a consumable product in response to one or more events.

### BACKGROUND

Traditionally, shelf life of consumable products, such as food items and medical products are indicated by a static label indicating information such as ‘Date of manufacturing’ and ‘best before’ date (or ‘Expiry Date’). Such information carries extreme importance as they indicate to a consumer the shelf life of the consumable product. The shelf life typically indicates the duration during which the quality of the consumable product is safe for consumption. Typically, the indicated shelf life for a consumable may be subject to one or more conditions being met. For example, the shelf life of a drug may be indicated to be six months from the date of manufacture subject to the condition that the drug is stored at a particular temperature. However, in reality, there may be numerous circumstances under which a product's quality may degrade well before the indicated ‘expiry date’ as specified conditions for storage or transport of the product may not be met.

In some cases, the consumable product may be continuously monitored to identify degradation of the consumable product. However, monitoring consumable products continuously over long periods of time to determine the quality of the consumable products may cause a drain on the processing and power resources of the monitoring system.

### SUMMARY

In one embodiment, a system for determining shelf life of a consumable product is disclosed. The system may comprise one or more activity monitoring sensors to detect an activity associated with the consumable product. The system further comprises one or more quality sensors to collect quality data of the consumable product upon detecting the activity. The system may also comprise a processor to determine shelf life of the consumable product based on the quality data of the consumable product.

In another embodiment, a method of determining shelf life of a consumable product is disclosed. The method may involve detecting, by one or more activity monitoring sensors, an activity associated with the consumable product; performing a quality check on the consumable product using one or more quality sensors upon detecting the activity; and determining shelf life of the consumable product, by a processor, based on the quality check on the consumable product.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates an exemplary flow diagram of a method of determining shelf life of a consumable product according to some embodiments of the present disclosure.

FIG. 2 is a functional block diagram of a system of determining shelf life of a consumable product according to some embodiments of the present disclosure.

FIG. 3 illustrates an exemplary patch for determining shelf life of a consumable product in accordance with some embodiments of the present disclosure.

FIG. 4 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

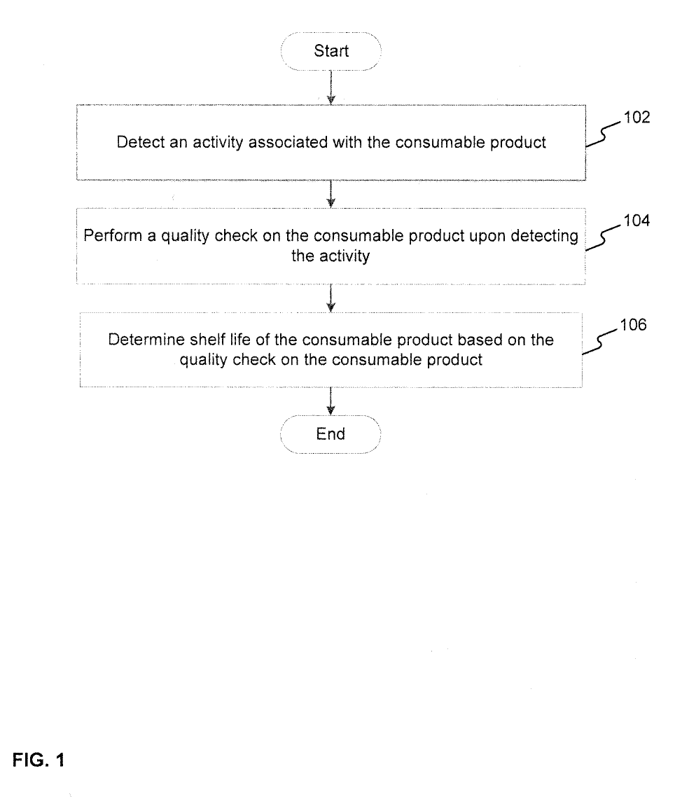

FIG. 1 illustrates an exemplary flow diagram of a method of determining shelf life of a consumable product, according to some embodiments of the present disclosure. The method may involve detecting, by one or more activity monitoring sensors, an activity associated with the consumable product at step 102. Here, the consumable product may include, but is not limited to, edible products and pharmaceutical products. Activities associated with the consumable products may include a positional change of the consumable product and/or a change in the environment of the consumable product. For example, an activity associated with the consumable product may include, moving, lifting, or shaking the consumable product. Further, an activity associated with the consumable product may include temperature variation or lighting variation in the environment in which the consumable is placed.

The activities associated with the consumable product may be detected using one or more activity monitoring sensors. In some embodiments, the activity monitoring sensors may be affixed on the consumable product. The activity monitoring sensors may include, but are not limited to a temperature sensor, an electro-optical sensor, a humidity sensor, a chemical sensor, a pressure sensor, an ultrasonic sensor, and an acceleration sensor. An activity associated with the consumable product may be detected based on a deviation of values of the one or more activity monitoring sensors from one or more baseline values of the activity monitoring sensors. For example, a change in orientation or tilt of the consumable product may be detected by an accelerometer if the accelerometer data deviates from one or more baseline values predefined for the accelerometer. The baseline values may be predefined in such a way as to minimize false positives. In this example, the baseline value may be set in order to determine significant positional change in the consumable product rather than smaller changes due to rocking while transporting, etc.

Similarly, a change in lighting conditions or exposure to direct sunlight or any other radiation may be detected by an electro-optical sensor. For example, the electro-optical sensor may detect movement of the consumable product from a dark storage place into direct sunlight. Presence of hazardous chemicals around the consumable product may be detected by the chemical sensor. Other sensors such as pressure sensors and weighing sensors may measure quantity variations in the consumable product. Leakage in the consumable product due to impact or collision of the consumable product may be detected by an ultrasonic sensor. If the consumable product is moved from a dry storage place and moved to an environment with moisture or if there is condensation of water around the consumable product, the humidity sensor may detect the activity.

On detecting an activity associated with the consumable product, a quality check may be performed on the consumable product at step 104. To perform the quality check one or more quality sensors may be used. The quality sensors may capture quality data of the consumable product and thereafter, the quality data may be used to perform the quality check. In some embodiments the quality sensors may be affixed on the consumable product. The quality sensors may include, but are not limited to, a spectral imager, a chemical sensor, a color light sensors, and a pressure sensor. A spectral imaging sensor may be a small surface area sensor which is capable of capturing images at ‘N’ different wavelengths of light. This may be achieved by adding a special filter on the sensor. The wavelengths supported by the sensor may be configured depending on the reflectance properties of the consumable product which varies with its quality. These wavelengths may vary for different consumable products and so the specifications of the spectral imager may also vary. Similarly, a chemical sensor may provide information about the chemical composition of the consumable product and/or the environment of the consumable product. The information may be provided in the form of a measurable physical signal that is correlated with the concentration of a certain chemical species. Also, the pressure sensor may be triggered to calculate the volume/weight of the substance remaining in the package. A color light sensor may be used to collect data on variation in color of the consumable product. For example, if the degradation or expiry of the consumable product is identified by its color, among other things, then the color light sensor may be triggered to capture the substance image and analyze the sensor data with reference color data. Based on the comparison with the reference color data, a color quality of the consumable product may be determined. Similarly, a chemical sensor may be used to determine a chemical quality of the consumable product.

At step 106, a shelf life of the consumable product may be determined based on the quality check on the consumable product. The shelf life may be determined based on the individual quality parameters measured by the quality sensors. For example, if the color of the consumable product has deteriorated by 10% from the reference data and the chemical composition has degraded by 2% from the reference data then, shelf life of the consumable may be determined to be 4 days. However, if the color of the consumable product has deteriorated by 10% and the chemical composition has degraded by 12%, then shelf life of the consumable may be determined to be 1 day.

In an exemplary embodiment, the consumable product may be a packet of mushrooms which is to be stored at 10 degrees below room temperature and in a dark and dry environment. During transportation, the mushrooms may be exposed to direct sunlight. The change in light and temperature may be detected by an electro-optical sensor and temperature sensor respectively. If the electro-optical sensor values and temperature sensor values are above the baseline values predefined for the light and temperature parameters for the mushrooms, then a quality check may be triggered. The quality sensors may check for the change in quality of the mushrooms due to the said activity. Mushroom decomposition may involve change in color from white to brown which may be measured by color light sensors release of organic gases which may be measured by a chemical sensor. The color light sensor data is compared to reference color light data associated color and the chemical sensor data is compared to reference chemical composition data of the mushroom. The color quality and the chemical quality of the mushrooms may hence be determined. The shelf-life of the mushrooms may then be determined based on the color quality and the chemical quality of the mushrooms. The shelf life may be determined using artificial intelligence techniques such as decision trees, neural networks, Support Vector Machines (SVMs) or regression models. Selection of the method may be based on the product characteristics and the sensors used.

Once the shelf-life is determined, the shelf life may be displayed to the consumer using a display or a status indicator. In some embodiments, a dynamic display unit could be integrated as part of packaging which may be used for indicating the shelf life. In another embodiment, this could be a passive indicator, which may be green or no-color when the consumable product is fit for consumption but changes to a different color such as red when the product quality degrades and may no longer be fit for consumption.

In some embodiments, a status of the product may be displayed on the dynamic display. For example, on initialization, the status may be set as ‘PACKED’ and the instructions configured for this mode may be executed when needed. When the product is sold, the status may be changed to ‘PURCHASED’. This may be achieved by tracking location information or using special devices at Point of Sale (POS) to change the state of the product. Depending on the activity associated with the consumable and the status of the substance, appropriate information associated with the consumable product may be displayed on the dynamic display. For example, if the consumable product is at a shop, the seal is not broken, and motion of the product is detected, it may be inferred that a customer is willing to buy the product and accordingly, a shelf life, a volume and a retail price of the consumable product may be displayed on the dynamic display. Similarly, based on the activity monitoring sensors, if the seal is detected to be opened and motion of the product is detected, it may be inferred that the customer is about to use the product and instructions before use—such as “shake well before use” may be displayed.

The method disclosed herein enables saving of processor and power resources as the quality check is performed only upon detection of an activity. The quality sensors are activated only when the activity is detected. The shelf-life of the consumable product is determined based on the handling and storing of the consumable product and in some cases, the determined shelf life may exceed the typical expiry date if the product is handled and/or stored correctly. Further, by providing usage instructions based on an activity associated with the consumable product, proper usage of the product may be enforced.

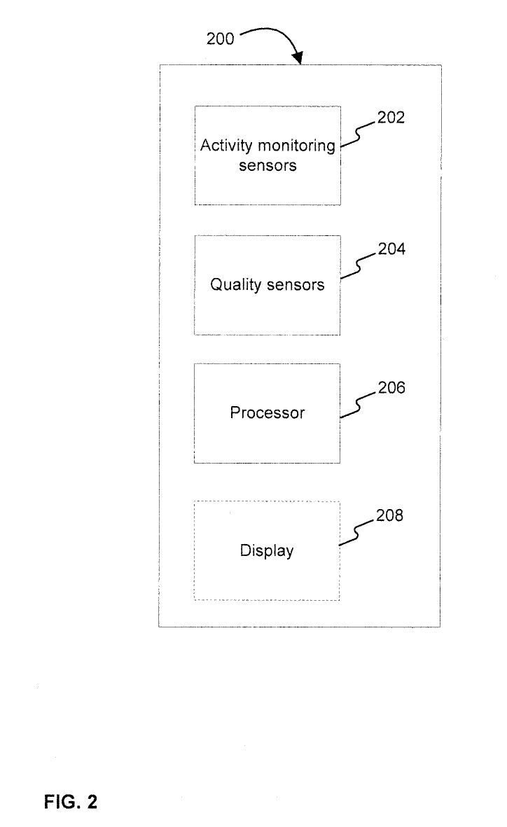

FIG. 2 illustrates an exemplary shelf life analysis computing device 200 for determining shelf life of a consumable product, according to some embodiments of the present disclosure. As shown in FIG. 2, system 200 comprises one or more activity monitoring sensors 202, one or more quality sensors 204, a processor 206, and optionally, a display 208. Activity monitoring sensors 202 may detect an activity associated with the consumable product. Activity monitoring sensors 202 may include, but are not limited to, a temperature sensor, an electro-optical sensor, a humidity sensor, a chemical sensor, a pressure sensor, an ultrasonic sensor, and an acceleration sensor. Activities associated with the consumable products may include a positional change of the consumable product and/or a change in the environment of the consumable product. Activity monitoring sensors 202 may detect positional changes of the consumable product such as moving of the consumable, lifting the consumable, etc. Activity monitoring sensors 202 may also detect environmental changes around the consumable product. Activity monitoring sensors 202 may detect an activity associated with the consumable product by comparing activity monitoring sensor values with baseline values as explained in conjunction with FIG. 1.

Once the activity monitoring sensors 202 detect an activity associated with the consumable product, one or more quality sensors 204 may collect quality data of the consumable product. Quality sensors 204 may include, but are not limited to, a spectral imager, a chemical sensor, a color light sensors, and a pressure sensor. Each of the one or more quality sensors may capture quality data corresponding to a particular quality parameter. For example, a chemical sensor may capture quality data corresponding to the chemical composition of the consumable product and/or the environment of the consumable product. Similarly, a color light sensor may be used to collect data on variation in color of the consumable product. Processor 206 may then perform a quality check for each quality parameter based on the quality data captured for each quality parameter.

Processor 206 may calculate the shelf-life of the consumable product on completion of the quality check. In other words, processor 206 may compare the quality data of the one or more quality sensors 204 with reference data associated with the one or more quality sensors 204 to determine the shelf life. The shelf life may be determined based on the individual quality parameters measured by the quality sensors as explained in conjunction with FIG. 1.

Once the shelf-life is determined, the shelf life may be displayed to the consumer through a display 208 or a status indicator (not shown in FIG. 2). In some embodiments, display 208 may include a dynamic display unit integrated as part of the packaging for the consumable product. In another embodiment, display 208 could be a passive indicator, which may be green or no-color when the consumable product is fit for consumption but changes to a different color such as red when the product quality degrades and may no longer be fit for consumption.

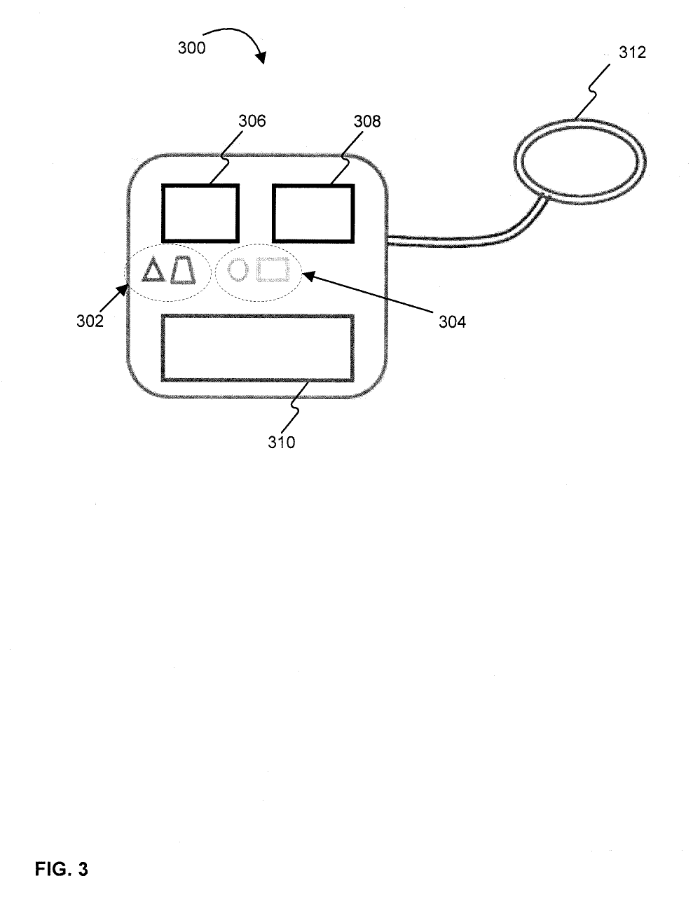

FIG. 3 illustrates an exemplary patch 300 for determining shelf life of a consumable product in accordance with some embodiments of the present disclosure. Patch 300 may be in the form of a flexible electronic circuit which contains one or more activity monitoring sensors 302, one or more quality sensors 304, a memory 306, a processor 308, a flexible power source 310 and a display 312. The patch 300 may be affixed to the consumable product. The patch 300 may also be integrated with the packaging such as bottles, cardboard boxes. Activity monitoring sensors 302 associated with patch 300 may detect one or more activities associated with the consumable product when patch 300 is affixed to the consumable product or to the packaging. Activity monitoring sensors 302 may be similar to activity monitoring sensors explained in conjunction with FIG. 1.

On detecting one or more activities, quality sensors 304 may capture quality data associated with the consumable product. Processor 308 may perform a quality check for various quality parameters based on the quality data as described in conjunction with FIG. 2. Flexible power source 310 such as a flexible battery may supply power required for the one or more activity monitoring sensors 302, the one or more quality sensors 304, the memory 306, the processor 308, and the status indicator 312. The memory 306 may be a static or programmable memory which stores baseline values for comparison with activity sensor value and the reference quality data for comparison with quality sensor data.

Patch 300 may further include a display 312 to display shelf life of the consumable product, status, or one or more usage instructions based on the activity detected by activity monitoring sensors 302. In some embodiments, display 312 may be a passive indicator, which may be green or no-color when the product quality is good but may change to a different color (ex. red) when the product quality degrades. It will be apparent to a person skilled in the art that although some exemplary displays are described herein, other displays may also be used without deviating from the scope of the present disclosure.

### Computer System

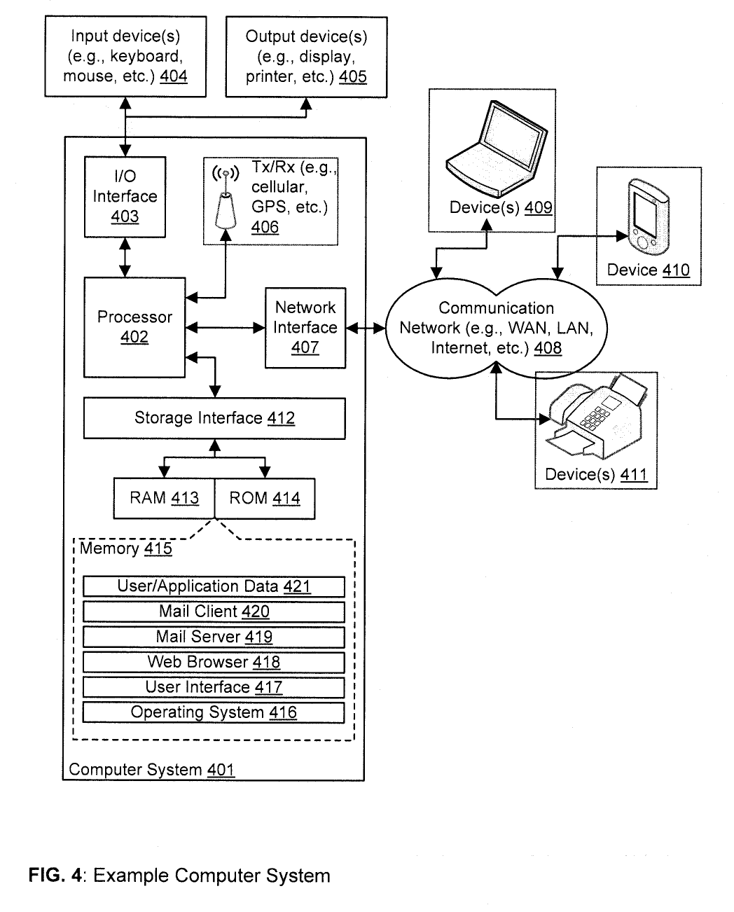

FIG. 4 is a block diagram of an exemplary computer system for implementing embodiments consistent with the present disclosure. Variations of computer system 401 may be used for implementing system 200. Computer system 401 may comprise a central processing unit (“CPU” or “processor”) 402. Processor 402 may comprise at least one data processor for executing program components for executing user- or system-generated requests. A user may include a person, a person using a device such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 402 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 402 may be disposed in communication with one or more input/output (I/O) devices via I/O interface 403. The I/O interface 403 may employ communication protocols/methods such as, without limitation, audio, analog, digital, monaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 403, the computer system 401 may communicate with one or more I/O devices. For example, the input device 404 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 405 may be a printer, fax machine, video display (e.g., cathode ray tube (CRT), liquid crystal display (LCD), light-emitting diode (LED), plasma, or the like), audio speaker, etc. In some embodiments, a transceiver 406 may be disposed in connection with the processor 402. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 402 may be disposed in communication with a communication network 408 via a network interface 407. The network interface 407 may communicate with the communication network 408. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 408 may include, without limitation, a direct interconnection, local area network (LAN), wide area network (WAN), wireless network (e.g., using Wireless Application Protocol), the Internet, etc. Using the network interface 407 and the communication network 408, the computer system 401 may communicate with devices 410, 411, and 412. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 401 may itself embody one or more of these devices.

In some embodiments, the processor 402 may be disposed in communication with one or more memory devices (e.g., RAM 413, ROM 414, etc.) via a storage interface 412. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 416, user interface application 417, web browser 418, mail server 419, mail client 420, user/application data 421 (e.g., any data variables or data records discussed in this disclosure), etc. The operating system 416 may facilitate resource management and operation of the computer system 401. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 417 may facilitate display, execution, interaction, manipulation, or operation of program components through textual or graphical facilities. For example, user interfaces may provide computer interaction interface elements on a display system operatively connected to the computer system 401, such as cursors, icons, check boxes, menus, scrollbars, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 401 may implement a web browser 418 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 401 may implement a mail server 419 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 401 may implement a mail client 420 stored program component. The mail client may be a mail viewing application, such as Apple Mail, Microsoft Entourage, Microsoft Outlook, Mozilla Thunderbird, etc.

In some embodiments, computer system 401 may store user/application data 421, such as the data, variables, records, etc. (e.g., baseline values for comparison with activity sensor values and reference quality data for comparison with quality sensor data) as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

The specification has described a method and system of determining shelf life of a consumable product. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for determining consumable product shelf life, the method comprising:
detecting, by one or more activity monitoring sensors of a shelf life analysis computing device, an activity associated with a consumable product;
performing, by one or more quality sensors of the shelf life analysis computing device, a quality check on the consumable product upon detecting the activity; and
determining, by the shelf life analysis computing device, a shelf life value for the consumable product based at least in part on the quality check performed on the consumable product.

2. The method of claim 1, wherein the activity associated with the consumable product is at least one of a positional change of the consumable product or a change in environment of the consumable product.

3. The method of claim 1, further comprising displaying, by the shelf life analysis computing device, data associated with the consumable product to a user, based on the activity associated with the consumable product.

4. The method of claim 1, wherein:
at least one of the one or more activity monitoring sensors or the one or more quality sensors are affixed to the consumable product;
the one or more activity monitoring sensors comprise one or more of a temperature sensor, an electro-optical sensor, a humidity sensor, a chemical sensor, a pressure sensor, an ultrasonic sensor, or an acceleration sensor; and
the one or more quality sensors comprise one or more of a spectral imager, a chemical sensor, color light sensors, or a pressure sensor.

5. The method of claim 1, wherein the activity is detected based on a deviation of values of the one or more activity monitoring sensors from one or more baseline values of the activity monitoring sensors.

6. The method of claim 1, wherein performing the quality check on the consumable product further comprises comparing quality data of the one or more quality sensors with reference data associated with the one or more quality sensors.

7. A shelf life analysis computing device comprising a processor and a memory coupled to the processor which is configured to be capable of executing programmed instructions comprising and stored in the memory to:
detect, by one or more activity monitoring sensors, an activity associated with a consumable product;
perform, by one or more quality sensors, a quality check on the consumable product upon detecting the activity; and
determine a shelf life value for the consumable product based at least in part on the quality check performed on the consumable product.

8. The shelf life analysis computing device of claim 7, wherein the activity associated with the consumable product is at least one of a positional change of the consumable product or a change in environment of the consumable product.

9. The shelf life analysis computing device of claim 7, wherein the processor is further configured to be capable of executing at least one additional programmed instructions comprising and stored in the memory to display data associated with the consumable product to a user, based on the activity associated with the consumable product.

10. The shelf life analysis computing device of claim 7, wherein:
at least one of the one or more activity monitoring sensors or the one or more quality sensors are affixed to the consumable product;
the one or more activity monitoring sensors comprise one or more of a temperature sensor, an electro-optical sensor, a humidity sensor, a chemical sensor, a pressure sensor, an ultrasonic sensor, or an acceleration sensor; and
the one or more quality sensors comprise one or more of a spectral imager, a chemical sensor, color light sensors, or a pressure sensor.

11. The shelf life analysis computing device of claim 7, wherein the activity is detected based on a deviation of values of the one or more activity monitoring sensors from one or more baseline values of the activity monitoring sensors.

12. The shelf life analysis computing device of claim 7, wherein the processor is further configured to be capable of executing at least one additional programmed instructions comprising and stored in the memory to compare quality data of the one or more quality sensors with reference data associated with the one or more quality sensors.

13. A non-transitory computer readable medium having stored thereon instructions for determining consumable product shelf life executable code which when executed by at least one processor, causes the processor to perform steps comprising:
detecting, by one or more activity monitoring sensors, an activity associated with a consumable product;
performing, by one or more quality sensors, a quality check on the consumable product upon detecting the activity; and
determining a shelf life value for the consumable product based at least in part on the quality check performed on the consumable product.

14. The non-transitory computer readable medium of claim 13, wherein the activity associated with the consumable product is at least one of a positional change of the consumable product or a change in environment of the consumable product.

15. The non-transitory computer readable medium of claim 13, further having stored thereon instructions comprising executable code which when executed by the processor further causes the processor to perform at least one additional step comprising displaying data associated with the consumable product to a user, based on the activity associated with the consumable product.

16. The non-transitory computer readable medium of claim 13, wherein:
at least one of the one or more activity monitoring sensors or the one or more quality sensors are affixed to the consumable product;
the one or more activity monitoring sensors comprise one or more of a temperature sensor, an electro-optical sensor, a humidity sensor, a chemical sensor, a pressure sensor, an ultrasonic sensor, or an acceleration sensor; and
the one or more quality sensors comprise one or more of a spectral imager, a chemical sensor, color light sensors, or a pressure sensor.

17. The non-transitory computer readable medium of claim 13, wherein the activity is detected based on a deviation of values of the one or more activity monitoring sensors from one or more baseline values of the activity monitoring sensors.

18. The non-transitory computer readable medium of claim 13, wherein performing the quality check on the consumable product further comprises comparing quality data of the one or more quality sensors with reference data associated with the one or more quality sensors.
